(19) United States
(12) Patent Application Publication
(10) Pub. No.: US 2017/0145856 A1
(43) Pub. Date: May 25, 2017

(54) CYLINDRICAL AIR GUIDE IN A TURBINE ENGINE

(71) Applicant: General Electric Company, Schenectady, NY (US)

(72) Inventors: Christopher Mark Bordne, Redlands, CA (US); Jeremy Stephen Wigon, Topsfield, MA (US)

(21) Appl. No.: 14/950,252

(22) Filed: Nov. 24, 2015

(51) Int. Cl. F01D 25/18; F02C 7/04; F02C 7/36

(52) U.S. Cl. CPC F01D 25/18; F02C 7/36; F02C 7/04

(57) ABSTRACT

An air/oil separator for a gas turbine engine includes a drive shaft having a central axis extending in an axial direction, a free vortex chamber mounted radially around the drive shaft, a separation chamber coupled with the free vortex chamber in the axial direction opposite to the drive shaft, and a rotatable outlet shaft radially rotatable and having an inlet end coupled with the separation chamber opposite to the free vortex chamber, an outlet end, and a hollow interior chamber therebetween. The hollow interior chamber has an inner circumference extending in the axial direction a cylindrical air guide extending coaxially therein. The cylindrical air guide has a nonporous cylindrical main body, an upstream end fixedly coupled with the inlet end of the rotatable outlet shaft, and a downstream end coaxially disposed within the outlet end of the rotatable outlet shaft.

### BACKGROUND

The field of the disclosure relates generally to gas turbine engines and, more particularly, to an air guide to control air flow from an air/oil separator in a gas turbine engine.

Gas turbine engines typically include an air/oil separator (AOS), also known as deoilers, as part of a vented sump system to separate air that is intermixed with oil in the bearing compartments and gearboxes of the gas turbine engine. Separated air exits the AOS through a vent line in a high-speed free, that is, unforced-rotational, vortex in a hollow exit shaft. The exiting air travels at an axial speed downstream a length of the hollow shaft, while also swirling at a radial, or rotational, flow velocity around an inner circumference of the exit shaft. In the free vortex, the rotational flow velocity of the air is inversely proportional to the distance from the axial center of the hollow shaft, and thus the rotational velocity of the air traveling down the central axis of the hollow shaft is significantly higher in the rotational velocity of the air traveling near the inner circumference of the hollow shaft. This difference in rotational velocities in the free vortex creates air friction, which results in undesirable loss in pressure down the shaft.

At least some conventional AOS venting systems have been known to place baffles down the central axis of the hollow shaft in a radial cross configuration, thereby dividing the hollow shaft into four radial quadrants down its length. This approach, however, creates miniature vortexes in each of the quadrants, which are subject to undesirable pressure loss from vortex air friction. Additionally, the irregular radial shape is another source of air friction that contributes to pressure loss.

### BRIEF DESCRIPTION

In one embodiment, an air/oil separator for a gas turbine engine includes a drive shaft having a central axis extending in an axial direction, a free vortex chamber mounted radially around the drive shaft, a separation chamber coupled with the free vortex chamber in the axial direction opposite to the drive shaft, and a rotatable outlet shaft having an inlet end, an outlet end, and a hollow interior chamber therebetween. The hollow interior chamber has an inner circumference extending in the axial direction, the inlet end coupled with the separation chamber opposite to the free vortex chamber, and the rotatable outlet shaft radially rotatable around the axial direction. The air/oil separator further includes a cylindrical air guide having a nonporous cylindrical main body with an outer circumference extending coaxially within the inner circumference of the hollow interior chamber of the rotatable outlet shaft. The cylindrical air guide further includes an upstream end fixedly coupled with the inlet end of the rotatable outlet shaft, and a downstream end coaxially disposed within the outlet end of the rotatable outlet shaft.

In another embodiment, a method for discharging exhaust air from air/oil separator of a gas turbine engine, the air/oil separator having a separation chamber and a hollow rotatable outlet shaft, includes venting exhaust air from the separation chamber into a first end of the hollow rotatable outlet shaft through air discharge slots in a direction substantially perpendicular to a longitudinal central axis of the hollow rotatable outlet shaft. The air discharge slots provide air communication between the separation chamber and the rotatable outlet shaft. The method further includes rotating the rotatable outlet shaft around the longitudinal central axis, and guiding airflow of the exhaust air through the hollow rotatable outlet shaft, from a first end of the shaft to a second opposing end thereof, radially around a cylindrical air guide coaxially mounted within the rotating outlet shaft about the longitudinal central axis, while preventing airflow from reaching the central longitudinal axis.

In yet another embodiment, a gas turbine engine includes a core engine, a compressor, a high pressure turbine, a low pressure turbine, a combustor assembly, a fan, a rotor, and an air/oil separator. The air/oil separator includes a drive shaft having a central axis extending in an axial direction. The drive shaft is coupled with the gas turbine engine rotor. The air/oil separator further includes a free vortex chamber mounted radially around the drive shaft, a separation chamber coupled with the free vortex chamber in the axial direction opposite to the drive shaft, and a rotatable outlet shaft having an inlet end, an outlet end, and a hollow interior chamber therebetween. The hollow interior chamber has an inner circumference extending in the axial direction, the inlet end coupled with the separation chamber opposite to the free vortex chamber, and the rotatable outlet shaft radially rotatable around the axial direction. The air/oil separator further includes a cylindrical air guide having a nonporous cylindrical main body with an outer circumference extending coaxially within the inner circumference of the hollow interior chamber of the rotatable outlet shaft. The cylindrical air guide further includes an upstream end fixedly coupled with the inlet end of the rotatable outlet shaft, and a downstream end fixedly coupled with the outlet end of the rotatable outlet shaft.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIGS. 1-4 show example embodiments of the method and system described herein.

FIG. 1 illustrates a sectional schematic view of a gas turbine engine.

FIG. 2 illustrates an oblique perspective view of an air/oil separator.

FIG. 3 illustrates a sectional perspective view of an air/oil separator for a gas turbine engine, in which an aspect of the methods and systems described herein may be employed in accordance with one embodiment of the present disclosure.

FIG. 4 illustrates a sectional schematic view of an exemplary embodiment of an air/oil separator for a gas turbine engine.

Although specific features of various embodiments may be shown in some drawings and not in others, this is for convenience only. Any feature of any drawing may be referenced and/or claimed in combination with any feature of any other drawing.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

The following detailed description illustrates embodiments of the disclosure by way of example and not by way of limitation. It is contemplated that the disclosure has general application to increasing recovered pressure from airflow into a bleed cavity of a gas turbine engine.

The following description refers to the accompanying drawings, in which, in the absence of a contrary representation, the same numbers in different drawings represent similar elements.

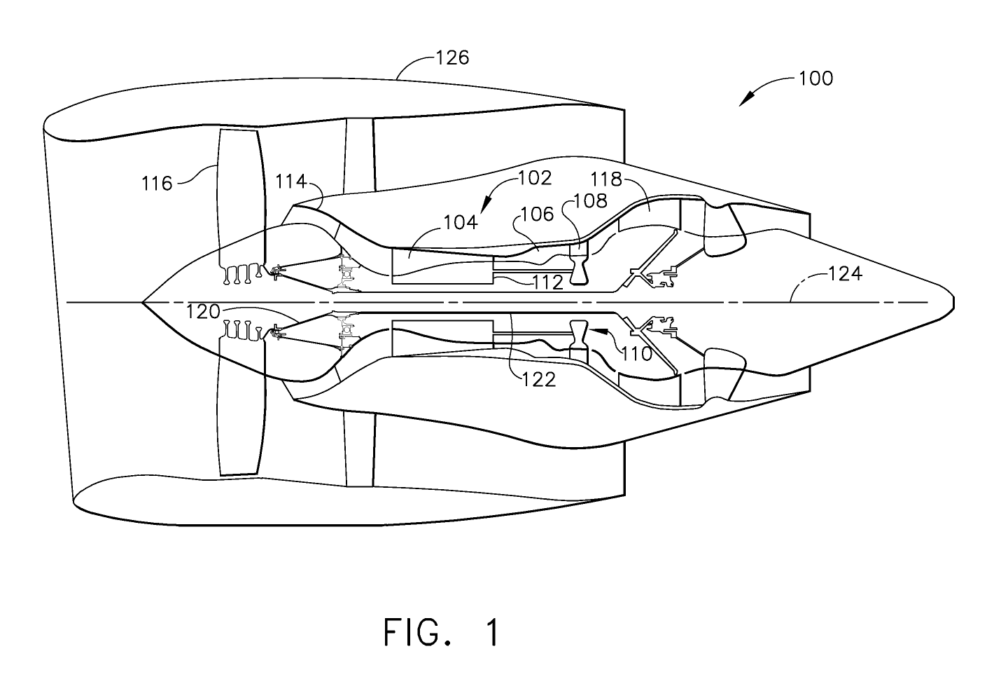

FIG. 1 is a schematic illustration of an exemplary gas turbine engine 100. Gas turbine engine 100 includes a gas generator or core engine 102 that includes a high pressure compressor (HPC) 104, a combustor assembly 106, and a high pressure turbine (HPT) 108 in an axial serial flow relationship on a core engine rotor 110 rotating about a core engine shaft 112. Gas turbine engine 100 also includes a low pressure compressor 114 and a fan 116, and a low pressure turbine 118 arranged in an axial flow relationship on an engine rotor 120 by power engine shaft 122.

During operation, air flows along a central axis 124, and compressed air is supplied to high pressure compressor 104. Highly compressed air is then delivered to combustor assembly 106. Exhaust gas flow from combustor assembly 106 drives turbine 108, and turbine 108 drives engine rotor 120, in addition to low pressure compressor 114 and fan 116. Gas turbine engine 100 also includes a containment case 126 for low pressure compressor 114 and fan 116.

Furthermore, additional and/or different elements not shown may be contained in, or coupled to the elements shown in FIG. 1, and/or certain illustrated elements may be absent. In some examples, the functions provided by the illustrated elements could be performed by less than the illustrated number of components or even by a single element.

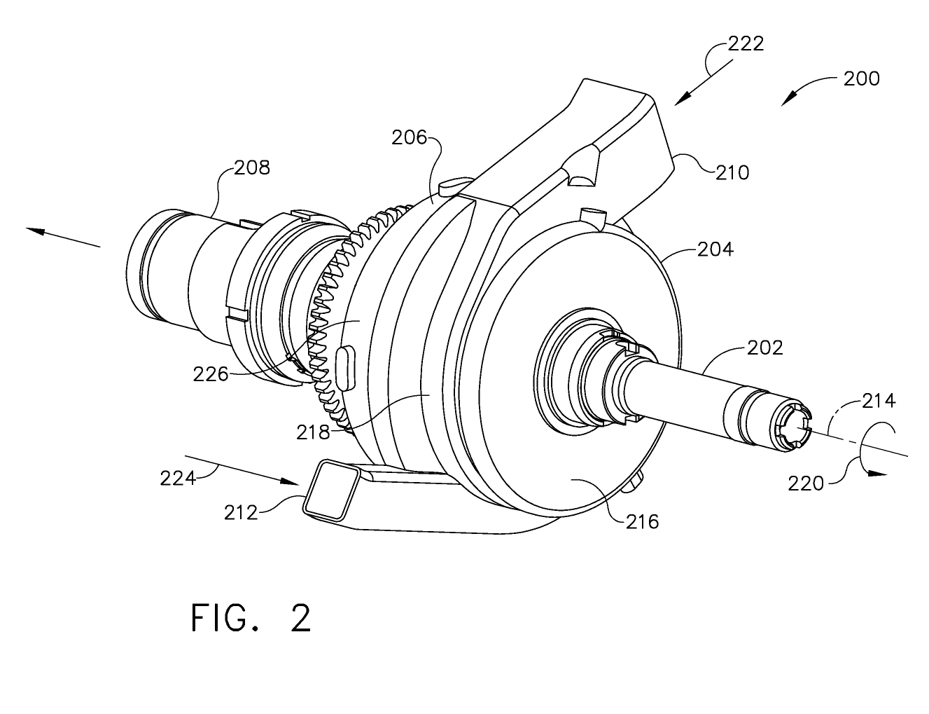

FIG. 2 illustrates an embodiment of an air/oil separator (AOS) 200 for a gas turbine engine (e.g., gas turbine engine 100, FIG. 1). In an exemplary embodiment, AOS 200 is a rotating free vortex configuration, and includes a drive shaft 202, a free vortex chamber 204, a separation chamber 206, and a rotatable outlet shaft 208. Free vortex chamber 204 includes a vent inlet 210 and a scavenging inlet 212.

Drive shaft 202 extends in an axial direction down central axis 214 and is coupled to a forward portion 216 of free vortex chamber 204. Separation chamber 206 couples with free vortex chamber 204 along central axis 214 opposite drive shaft 202. Rotatable outlet shaft 208 couples with separation chamber 206 along central axis 214 opposite free vortex chamber 204. Vent inlet 210 and scavenging inlet 212 approach free vortex chamber 204 tangentially to an outer circumference 218 of free vortex chamber 204, and in a direction of rotation 220 of rotatable outlet shaft 208.

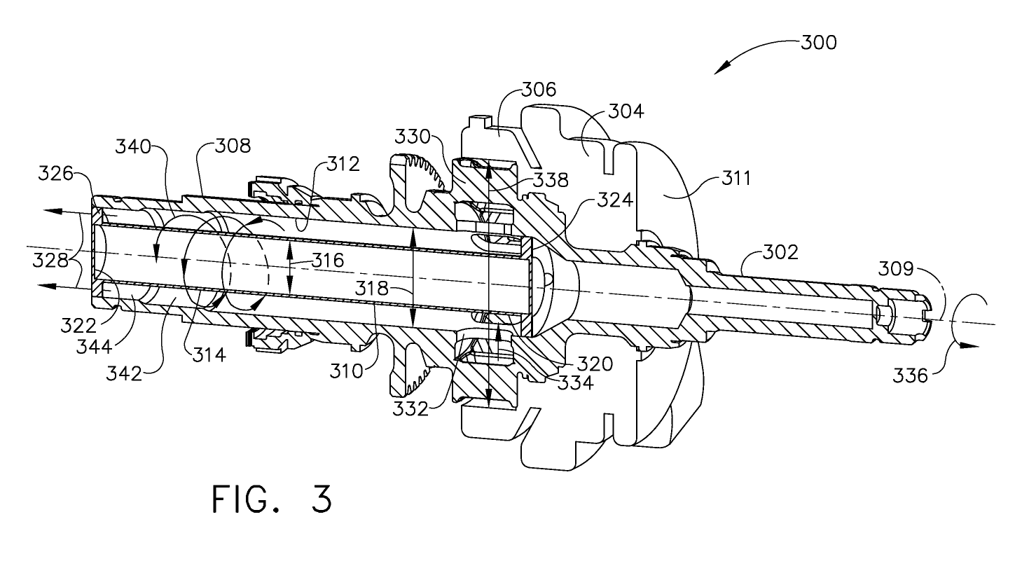

In operation, air-oil mixtures flow into vent inlet 210 from direction 222, and into scavenging inlet 212 from direction 224, and the two air-oil mixtures are combined at high rotational speeds within free vortex chamber 204 around drive shaft 202. The rotating air-oil mixture proceeds from free vortex chamber 204 into separation chamber 206 and encounters rotating separator vanes (see element 330, FIG. 3), which steer encountered oil droplets from the combined mixture radially toward an outer wall 226 of separation chamber 206 by centrifugal action of rotating separator vanes. Once reaching outer wall 226, the radially steered oil can be collected and fed back into the engine as desired. In an exemplary embodiment, AOS 200 can be integrated axially or radially with a gearbox drive shaft, a low pressure turbine shaft or other suitable rotating components shown in FIG. 1.

FIG. 3 illustrates an exemplary embodiment of an AOS 300 for a gas turbine engine (e.g., gas turbine engine 100, FIG. 1). AOS 300 is similar to AOS 200 (FIG. 2) in external construction and overall function. In an aspect of the embodiment, AOS 300 is also a rotating free vortex configuration, and similarly includes a drive shaft 302, a free vortex chamber 304, a separation chamber 306, and a rotatable outlet shaft 308.

Drive shaft 302 extends in an axial direction down central axis 309 and is coupled to a forward portion 311 of free vortex chamber 304. Separation chamber 306 couples with free vortex chamber 304 along central axis 309 on a side of free vortex chamber (not numbered) opposite drive shaft 302. Rotatable outlet shaft 308 couples with separation chamber 306 along central axis 309 on a side (not numbered) of separation chamber 306 opposite free vortex chamber 304. Rotatable outlet shaft 308 includes a cylindrical air guide 310 disposed along central axis 309 within an inner circumference 312 of rotatable outlet shaft 308. Cylindrical air guide 310 includes a nonporous outer wall 314 having an outer diameter 316. Inner circumference 312 of rotatable outlet shaft 308 has a diameter 318 that is greater than diameter 316 of cylindrical air guide 310.

Cylindrical air guide 310 further includes an upstream end 320 and a downstream end 322. Nonporous outer wall 314 of cylindrical air guide 310 is cylindrically shaped, and runs substantially parallel to inner circumference 312 of rotatable outlet shaft 308 from upstream end 320 to downstream end 322. In this exemplary embodiment, upstream end 320 of cylindrical air guide 310 is fixedly attached to inner circumference 312 of rotatable outlet shaft 308, between free vortex chamber 304 and separation chamber 306, by an upstream mount 324. Upstream mount 324 is ring-shaped or disc-shaped, is nonporous and extends between cylindrical air guide 310 and rotatable outlet shaft 308. Upstream mount 324 prevents airflow between cylindrical air guide 310 and rotatable outlet shaft 308 from moving upstream toward drive shaft 302.

In the exemplary embodiment, downstream end 322 of cylindrical air guide 310 is not fixedly attached to inner circumference 312 of rotatable outlet shaft 308, and is held coaxially with inner circumference 312 by the cantilevered attachment of upstream end 320 to inner circumference 312 by upstream mount 324. In an alternative embodiment, downstream end 322 is fixedly attached to inner circumference 312 of rotatable shaft 308 by a mounting fastener 326. In one embodiment, mounting fastener 326 is a single bolt passing through downstream end 322 and across the entirety of inner diameter 318. In further alternative embodiments, mounting fastener 326 includes a plurality of connectors, or a single mounting spider configuration, fixedly attaching nonporous outer wall 314 to inner circumference 312. Mounting fastener 326 is configured to allow airflow between cylindrical air guide 310 and rotatable outlet shaft 308 while exiting rotatable outlet shaft 308 in an exit direction 328.

In operation, an air-oil mixture is injected into free vortex chamber 304 through a vent inlet (see element 210, FIG. 2) and a scavenging inlet (see element 212, FIG. 2), and the combined air-oil mixture is rotated together at high speeds (e.g. 12,000 rpm or greater) to create a free vortex phenomenon within free vortex chamber 304. The free vortex in free vortex chamber 304 allows relatively large oil particles to be separated from the air/air-oil mixture and propelled radially outward toward an outer circumference (e.g., outer circumference 218, FIG. 2) of free vortex chamber 304 for collection and redistribution. The “large” oil particles are those having sufficient size such that they can be moved outwardly by the force of the free vortex alone within free vortex chamber 304. The free vortexing air-oil mixture then flows into separation chamber 306 through a passage (not shown) between free vortex chamber 304 and separation chamber 306, where a plurality of rotating separator vanes 330 remove smaller oil particles from the mixture, as described above with respect to FIG. 2. The “small” oil particles are those having sufficient size such that they can condense on rotating separator vanes 330 and then be moved outwardly by centrifugal force of the spinning vanes. Substantially oil-free exhaust air is then forced from separation chamber 306 through air discharge slots 332 in rotatable outlet shaft 308 in a radial direction 334. Air discharge slots 332 allow air communication between rotatable outlet shaft 308 and separation chamber 306.

In further operation, rotatable outlet shaft 308 and rotating separator vanes 330 rotate in a rotational direction 336 at a significant percentage of the rotational speed of the core engine rotor about the core engine shaft (e.g., elements 110, 112, respectively, FIG. 1). Air flowing into rotatable outlet shaft 308 from air discharge slots 332 rotates around central axis 309, at a percentage of the rotational speed of rotatable outlet shaft 308, due to air friction with rotating inner circumference 312 of rotatable outlet shaft 308. Upstream mount 324 and mounting fastener 326 fixedly couple cylindrical air guide 310 to rotatable outlet shaft 308 such that cylindrical air guide 310 rotates at the same rotational speed as rotatable outlet shaft 308.

In an exemplary embodiment, an inner diameter 338 of separation chamber 306 is greater than inner diameter 318 of rotatable outlet shaft 308, and therefore rotational speed of air entering rotatable outlet shaft 308 is greater than the rotational speed of the air in separation chamber 306. The rotation of the swirling air entering rotatable outlet shaft 308 is faster as the air gets closer to central axis 309. This relative acceleration of air with respect to smaller radii is what is known as the free vortexing phenomenon that airflow exhibits within cylindrical bodies.

In practice, cylindrical airflow through AOS 300 experiences a “tornado” effect, where the rotational velocity of air near central axis 309 can be seen to be more than five times greater than the rotational velocity of air entering rotatable outlet shaft 308 in direction 334. At the typical rotational speed of AOS 300 utilized in operation, for example, the rotational velocity of free vortexing air along central axis 309 within rotatable outlet shaft 308 can reach Mach 1 speeds, and thereby result significant in undesirable pressure losses.

Cylindrical air guide 310 is thus configured to create a smaller diameter (i.e., outer diameter 316), coaxial shaft within a larger shaft (i.e. rotatable outlet shaft 308 having inner diameter 318), thereby creating an annular flow path 340 through outlet shaft 308 around cylindrical air guide 310. Cylindrical air guide 310 prevents airflow from reaching central axis 309, and therefore also limits the difference in rotational velocities between airflow near inner circumference 312 and airflow near nonporous outer wall 314. By limiting this difference, air friction from the free vortex phenomenon is significantly reduced, and therefore the loss in pressure from upstream end 320 to downstream end 322 is also significantly reduced. In practice, air friction created near nonporous outer wall 314 of cylindrical air guide 310 is considerably less than the air friction known to be created at central axis 309 by the free vortex phenomenon, without the air guide present.

In an aspect of the embodiment, outer diameter 316 and inner diameter 318 are sized such that the annular, radial cross sectional area (not shown) of available airflow between the diameters is substantially equivalent to the radial cross sectional area of an outlet shaft of a conventional AOS. Too much of a decrease in the cross-sectional area of available airflow within the outlet shaft can also lead to pressure loss from having the same volume of airflow pass through a smaller opening. By increasing the inner diameter (i.e., inner diameter 318) of the outlet shaft (i.e., rotatable outlet shaft 308) to compensate for the loss of radial sectional area now centrally occupied by cylindrical air guide 310, a consistent radial cross-sectional area can be maintained. In an exemplary embodiment, inner diameter 318 of rotatable outlet shaft 308 can be gradually decreased in a first region 342 and a second region 344, respectively, of inner circumference 312 near downstream end 322, to further guide the airflow exiting in direction 328.

In a further aspect of the embodiment, inner circumference 312 of rotatable outlet shaft 308 and nonporous outer wall 314 of cylindrical air guide 310 are smooth surfaces, to further minimize friction from airflow near both respective surfaces. Smooth, rounded surfaces to both respective circumferences 312, 314 will also help to reduce pressure loss through AOS 300 by allowing the airflow to more easily transition the substantially ninety degree turn from direction 334 at upstream end 320, to direction 328 at downstream end 322. In an exemplary embodiment, downstream end 322 of cylindrical air guide 310 is aerodynamically shaped to further encourage a smooth exit to the airflow direction 328.

In a still further aspect of the embodiment, cylindrical air guide 310 has a hollow interior to avoid an unnecessary increase in the weight of AOS 300. For the same length, a cylindrical air guide according to the present embodiments weighs less than the conventional cross-shaped baffle, when the thickness of the cylinder wall is the same as the thickness of the spokes in the conventional cross-shaped baffle. Cylindrical air guide 310 therefore uses less material, and the cylindrical shape is easier to fabricate than the conventional cross-shape.

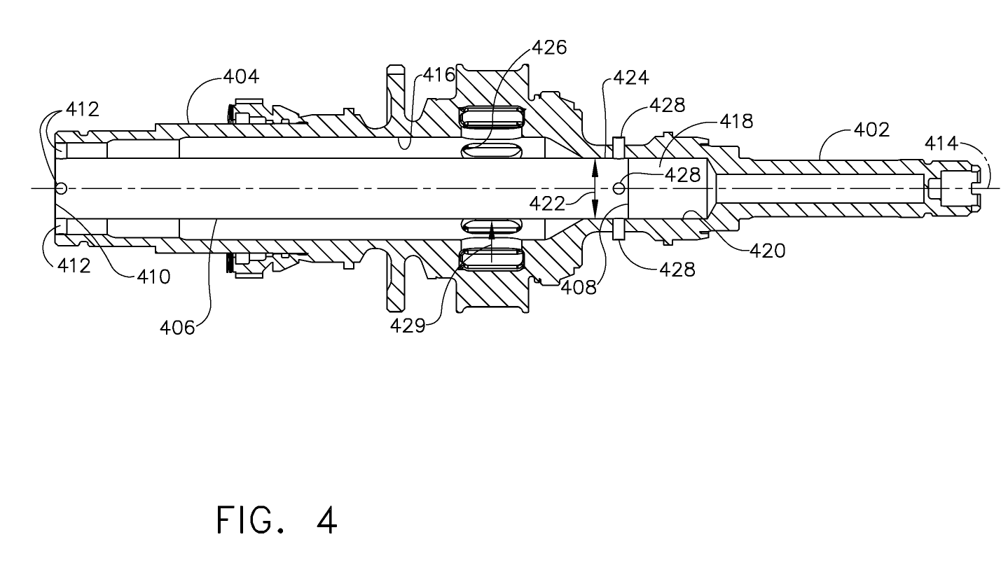

FIG. 4 illustrates an alternative exemplary embodiment of an AOS 400 for a gas turbine engine (e.g., gas turbine engine 100, FIG. 1). AOS 400 is similar to AOS 300 (FIG. 3) in construction and overall function, and differs primarily from AOS 300 with respect to how upstream end 320 of cylindrical air guide 310 couples with drive shaft 302. Similar to AOS 300, in an aspect of this alternative embodiment, AOS 400 is also a rotating free vortex configuration.

AOS 400 includes a drive shaft 402, a rotatable outlet shaft 404, and a cylindrical air guide 406. Cylindrical air guide 406 includes an upstream end 408 and a downstream end 410. Downstream end 410 fixedly attaches to rotatable outlet shaft 404 by a plurality of mounting connectors 412, similar to the attachment of downstream end 322 with rotatable outlet shaft 308 by mounting connector 326 in FIG. 3. Driveshaft 402, rotatable outlet shaft 404, and cylindrical air guide 406 extend in an axial direction along central axis 414, and cylindrical air guide 406 is coaxially mounted within an interior circumference 416 of rotatable outlet shaft 404.

Driveshaft 402 includes a hollow inner portion 418. Hollow inner portion 418 includes an interior circumference 420 sized to provide an interference fit with an outer diameter 422 of cylindrical air guide 406. In an aspect of the embodiment, outer diameter 422 of upstream end 408 securely fits within a region 424 of hollow inner portion 418 such that airflow into rotatable outlet shaft 404, from an air discharge slot in a direction 429, is prevented from traveling upstream into hollow inner portion 418. In an optional configuration, upstream end 408 of cylindrical air guide 406 is alternatively, or additionally, fixedly secured to driveshaft 402 by one or more mounting connectors 428.

In an alternative embodiment, downstream end 410 does not fixedly attach to rotatable outlet shaft 404, and is instead cantilevered by the fixed attachment of outer diameter 422 to interior circumference 420 of hollow inner portion 418. In this configuration, downstream end is disposed within, and maintains a coaxial coupling with, interior circumference 420 without requiring a direct mounting connection to interior circumference 420. In an optional configuration of the alternative embodiment, downstream end is aerodynamically inwardly toward central axis 414 and in the direction of airflow exiting rotatable outlet shaft 404.

The foregoing detailed description illustrates embodiments of the disclosure by way of example and not by way of limitation. It is contemplated that the disclosure has general application to air/oil separators and sump venting for various purposes. It is further contemplated that the methods and systems described herein may be incorporated into existing aircraft engine designs and structures.

It will be appreciated that the above embodiments that have been described in particular detail are merely example or possible embodiments, and that there are many other combinations, additions, or alternatives that may be included. The apparatus illustrated is not limited to the specific embodiments described herein, but rather, components of each may be utilized independently and separately from other components described herein. Each system component can also be used in combination with other system components.

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

While the disclosure has been described in terms of various specific embodiments, it will be recognized that the disclosure can be practiced with modification within the spirit and scope of the claims.

This written description uses examples to describe the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An air/oil separator for a gas turbine engine, said air/oil separator comprising:
a drive shaft having a central axis extending in an axial direction;
a free vortex chamber mounted radially around said drive shaft;
a separation chamber coupled with said free vortex chamber in the axial direction on a side of said free vortex chamber opposite to said drive shaft;
a rotatable outlet shaft having an inlet end, an outlet end, and a hollow interior chamber therebetween, said hollow interior chamber having an inner circumference extending in the axial direction, said inlet end coupled with said separation chamber on a side of said separation chamber opposite to said free vortex chamber, and said rotatable outlet shaft radially rotatable about the central axis; and
a cylindrical air guide comprising;
a nonporous cylindrical main body having an outer circumference extending coaxially within the inner circumference of said hollow interior chamber of said rotatable outlet shaft;
an upstream end fixedly coupled with said inlet end of said rotatable outlet shaft; and
a downstream end coaxially disposed within said outlet end of said rotatable outlet shaft.

2. The air/oil separator of claim 1, wherein said rotatable outlet shaft further comprises a plurality of air discharge slots disposed radially about said hollow interior chamber at said inlet end.

3. The air/oil separator of claim 2, wherein said plurality of air discharge slots are configured to allow air communication between said separation chamber and said hollow interior chamber of said rotatable outlet shaft.

4. The air/oil separator of claim 3, further comprising an upstream mount, wherein said upstream end of said cylindrical air guide is fixedly coupled with said inlet end of said rotatable outlet shaft by said upstream mount, and wherein said upstream mount is mounted upstream of said plurality of air discharge slots.

5. The air/oil separator of claim 4, wherein said upstream mount is configured to prevent air flowing upstream of said plurality of air discharge slots within said hollow interior chamber.

6. The air/oil separator of claim 4, wherein said upstream mount is disc-shaped.

7. The air/oil separator of claim 4, wherein said upstream mount is ring-shaped.

8. The air/oil separator of claim 7, wherein said ring-shaped upstream mount has an inner circumference and an outer circumference, said inner circumference of said ring-shaped upstream mount configured to seal said ring-shaped upstream mount to said outer circumference of said upstream end of said cylindrical air guide, and said outer circumference of said ring-shaped upstream mount configured to seal said ring-shaped upstream mount to said inner circumference of said hollow interior chamber of said rotatable outlet shaft.

9. The air/oil separator of claim 3, wherein said drive shaft further comprises a hollow interior shaft opening located upstream of said plurality of air discharge slots, said hollow interior shaft opening having an inner dimension configured to allow an interference fit with said upstream end of said cylindrical air guide.

10. The air/oil separator of claim 9, wherein the interference fit of said upstream end of said cylindrical air guide with said hollow interior shaft opening of said drive shaft is configured to prevent air flowing upstream of said plurality of air discharge slots within said hollow interior chamber.

11. The air/oil separator of claim 10, further comprising at least one mounting connector fixedly attaching said upstream end of said cylindrical air guide to said driveshaft upstream of said plurality of air discharge slots.

12. The air/oil separator of claim 1, wherein said downstream end of said cylindrical air guide is fixedly coupled with said outlet end of said rotatable outlet shaft by at least one mounting connector.

13. The air/oil separator of claim 12, wherein said at least one mounting connector is configured to permit airflow from exiting said hollow interior chamber of said rotatable outlet shaft at said outlet end.

14. The air/oil separator of claim 1, wherein said downstream end of said cylindrical air guide is coaxially coupled with said outlet end of said rotatable outlet shaft by cantilevered support of said upstream end fixedly coupled with said inlet end of said rotatable outlet shaft.

15. The air/oil separator of claim 1, wherein said nonporous cylindrical main body comprises a cylindrical outer wall, and wherein said nonporous cylindrical main body is hollow inside of said cylindrical outer wall.

16. The air/oil separator of claim 1, wherein said hollow interior chamber of said rotatable shaft comprises a plurality of interior sections having a progressively smaller interior diameter approaching out end of said rotatable outlet shaft.

17. A method for discharging exhaust air from air/oil separator of a gas turbine engine, the air/oil separator having a separation chamber and a hollow rotatable outlet shaft, said method comprising:
venting exhaust air from the separation chamber into a first end of the hollow rotatable outlet shaft through air discharge slots in a direction substantially perpendicular to a longitudinal central axis of the hollow rotatable outlet shaft, the air discharge slots providing air communication between the separation chamber and the rotatable outlet shaft;
rotating the rotatable outlet shaft around the longitudinal central axis; and
guiding airflow of the exhaust air through the hollow rotatable outlet shaft, from a first end to a second opposing end thereof, radially around a cylindrical air guide coaxially mounted within the rotating outlet shaft about the longitudinal central axis, while preventing airflow from reaching the central longitudinal axis.

18. The method of claim 17, further comprising discharging the airflow from the second opposing end of the rotating hollow rotatable outlet shaft through a radial cross-sectional area between the rotating outlet shaft and the cylindrical air guide.

19. A gas turbine engine including a core engine, a compressor, a high pressure turbine, a low pressure turbine, a combustor assembly, a fan, and a rotor, said gas turbine engine comprising:
an air/oil separator comprising:
a drive shaft having a central axis extending in an axial direction, said drive shaft coupled with said gas turbine engine rotor;
a free vortex chamber mounted radially around said drive shaft;
a separation chamber coupled with said free vortex chamber in said axial direction on a side of said free vortex chamber opposite to said drive shaft;
a rotatable outlet shaft having an inlet end, an outlet end, and a hollow interior chamber therebetween, said hollow interior chamber having an inner circumference extending in the axial direction, said inlet end coupled with said separation chamber on a side of said separation chamber opposite to said free vortex chamber, and said rotatable outlet shaft radially rotatable around the axial direction; and
a cylindrical air guide comprising;
a nonporous cylindrical main body having an outer circumference extending coaxially within said inner circumference of said hollow interior chamber of said rotatable outlet shaft;
an upstream end fixedly coupled with said inlet end of said rotatable outlet shaft; and
a downstream end coaxially disposed within said outlet end of said rotatable outlet shaft.

20. The gas turbine engine of claim 19, further comprising a gearbox, wherein said drive shaft is radially coupled with said gearbox.
